(19) United States
(12) Patent Application Publication
(10) Pub. No.: US 2020/0242536 A1
(43) Pub. Date: Jul. 30, 2020

(54) AUTOMATED ROLE ENGINEERING FOR ENTERPRISE COMPUTER SYSTEMS

(71) Applicant: Capital One Services, LLC, McLean, VA (US)

(72) Inventor: Christian Schwantes, Midlothian, VA (US)

(73) Assignee: Capital One Services, LLC, McLean, VA (US)

(21) Appl. No.: 16/258,095

(22) Filed: Jan. 25, 2019

(51) Int. Cl. G06Q 10/06; H04L 29/06; G06Q 10/10; G06F 17/16

(52) U.S. Cl. CPC G06Q 10/063112; G06F 17/16; G06Q 10/10; H04L 63/104

(57) ABSTRACT

In some embodiments, a method for automatically assigning entitlements to user of an enterprise computer system comprises: receiving entitlement data that maps a plurality of users to a plurality of entitlements; receiving job responsibilities data that maps the plurality of users to a plurality of job responsibilities; generating role data and reduced entitlement data using non-negative matrix factorization (NMF), wherein the role data maps the plurality of job responsibilities to a plurality of roles, wherein the reduced entitlement data maps the plurality of roles to the plurality of entitlements; receiving job responsibility data for a user of the enterprise computer system; determining one or more entitlements for the user using the received job responsibility data, the role data, and reduced entitlement data; and sending the one or more entitlements determined for the user.

### BACKGROUND

At a large enterprise, when new hires and new team members join, such employees typically spend the first few weeks without the access to computer-based resources within the enterprise that they may want. Moreover, such employees spend a significant amount of their time trying to figure out what entitlements they do or do not want. Secondly, it is never clear to a manager of the large enterprise exactly when their direct reports want an entitlement within the large enterprise. Also, once such employees have an entitlement, they may very infrequently lose their entitlement due to organizational restructuring. This creates additional risk as some employees may have more access than they really need.

Some systems such as Roles-Based Access Control (RBAC) may group entitlements to be provisioned together into roles. However, these roles are created by hand which requires the domain-specific knowledge of what access certain teams/organizations within the large enterprise may want. Such a manual approach does not scale up, and often leads to a glut of roles that only apply in small populations within the large enterprise. Therefore, current RBAC systems do not have the ability to learn what roles to create and who to provision them to directly from the already existing access requirements of the large enterprise.

### SUMMARY

In an aspect of the present disclosure, a method for automatically assigning entitlements to users of an enterprise computer system may include: receiving, by one or more processors, entitlement data that maps a plurality of users to a plurality of entitlements; receiving job responsibilities data that maps the plurality of users to a plurality of job responsibilities; generating role data and reduced entitlement data by applying non-negative matrix factorization (NMF) to the entitlement data and the job responsibilities data, wherein the role data maps the plurality of job responsibilities to a plurality of roles, wherein the reduced entitlement data maps the plurality of roles to the plurality of entitlements; receiving, from a user device, job responsibility data for a user of the enterprise computer system; determining one or more entitlements for the user using the received job responsibility data, the role data, and reduced entitlement data; and sending, to the user device, the one or more entitlements determined for the user.

In some embodiments, the method can include generating, from the role data and the reduced entitlement data, binary role data and binary reduced entitlement data using a predetermined relevance parameter and a predetermined coverage parameter, wherein determining the one or more entitlements for the user comprises using the received job responsibility data, the binary role data, and binary reduced entitlement data. In some embodiments, the method may include determining one or more roles for the user using the received job responsibility data and the role data. In some embodiments, applying non-negative matrix factorization (NMF) to the entitlement data and the job responsibilities data comprises using the job responsibilities data as a constraint. In some embodiments, the entitlement data comprises a first binary matrix and the job responsibilities data comprises a second binary matrix.

In some embodiments, the method can include comprising performing a matrix multiplication of a matrix representing the entitlement data and a matrix representing the job responsibilities data, wherein the non-negative matrix factorization (NMF) is applied to a result of the matrix multiplication. In some embodiments, the plurality of job responsibilities comprises at least one of: a job family, a job level, a department, a reporting hierarchy, an organization, a supervisor name, a team name, or a team type. In some embodiments, receiving job responsibility data for the user comprises receiving job responsibility data for a user having no prior entitlements within the enterprise computer system. In some embodiments, the one or more entitlements comprise access rights to at least one of one: a compute resource, a data source, or a source code repository. In some embodiments, the method can include: receiving, from the user device, a request to update entitlements for the user; receiving updated binary role data and updated binary reduced entitlement data; and determining one or more updated entitlements for the user using the updated binary role data and the updated binary reduced entitlement data.

According to another aspect of the present disclosure, a method for automatically assigning entitlements to users of an enterprise computer system may include: receiving, by one or more processors, a users-to-entitlements matrix and users-to-job responsibilities matrix; generating a job responsibilities-to-role matrix and a role-to-entitlements matrix by applying non-negative matrix factorization (NMF) to a product of the users-to-entitlements matrix and the users-to-job responsibilities matrix; receiving job responsibility data for a user of the enterprise computer system; determining a role for the user using the job responsibility data for the user and the job responsibilities-to-role matrix; determining one or more entitlements for the user using the role determined for the user and the role-to-entitlements matrix; and granting the one or more entitlements to the user of the enterprise computer system.

In some embodiments, the method can include generating, from the responsibilities-to-role matrix, a binary responsibilities-to-role matrix using at least one of a predetermined relevance parameter or a predetermined coverage parameter wherein determining the role for the user comprises using the job responsibility data for the user and the binary job responsibilities-to-role matrix. In some embodiments, the method can include generating, from the role-to-entitlements matrix, a binary role-to-entitlements matrix using at least one of a predetermined relevance parameter and a predetermined coverage parameter, wherein determining the one or more entitlements for the user comprises using the role determined for the user and the binary role-to-entitlements matrix. In some embodiments, applying non-negative matrix factorization (NMF) to the product of the users-to-entitlements matrix and the users-to-job responsibilities matrix comprises using the users-to-job responsibilities matrix as a constraint.

In some embodiments, the users-to-entitlements matrix comprises a binary matrix that maps the plurality of users to a plurality of entitlements, wherein the users-to-job responsibilities matrix comprises a binary matrix that maps the plurality of users to a plurality of job responsibilities. In some embodiments, receiving job responsibility data for the user comprises receiving job responsibility data for a user having no prior entitlements within the enterprise computer system. In some embodiments, the one or more entitlements comprise access rights to at least one of one or more compute resources, one or more data source, one or more code repositories associated with the enterprise computer system. In some embodiments, the method can include performing a matrix multiplication of the users-to-entitlements matrix and the users-to-job responsibilities matrix. In some embodiments, applying non-negative matrix factorization (NMF) comprises performing an iterative numerical method using an objective function that relies on one or more approximation-orthogonality parameters.

According to another aspect of the present disclosure, a system can include a database; one or more processors; and a memory. The memory may store instructions executable by the one or more processors to: receive, from the database, entitlement data that maps a plurality of users to a plurality of entitlements; receive, from the database, job responsibilities data that maps the plurality of users to a plurality of job responsibilities; generate role data and reduced entitlement data by applying non-negative matrix factorization (NMF) to a product of the entitlement data and the job responsibilities data, wherein the role data maps the plurality of job responsibilities to a plurality of roles, wherein the reduced entitlement data maps the plurality of roles to the plurality of entitlements; receive, from a user device, job responsibility data for a user of the enterprise computer system; determine one or more entitlements for the user using the received job responsibility data, the role data, and reduced entitlement data; and send, to the user device, the one or more entitlements determined for the user.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of a system for automated role engineering using non-negative matrix factorization, according to some embodiments of the present disclosure.

FIG. 2 is a flow diagram showing processing that may occur within the system of FIG. 1, according to some embodiments of the present disclosure.

FIG. 3 is a flow diagram showing processing that may occur within the system of FIG. 1, according to some embodiments of the present disclosure.

FIGS. 4 and 5 illustrate user interfaces that can be used for automated role engineering within the system of FIG. 1, according to some embodiments of the present disclosure.

FIG. 6 is a block diagram of an example user device using the process performed by the system of FIG. 1, according to an embodiment of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Disclosed in the present disclosure, in one aspect, is a method for improving assignment of entitlements to users of an enterprise computer system. The users (or “subjects”) may be employees, contractors, owners or other persons associated with the enterprise.

### Non-Negative Matrix Factorization

As disclosed herein, non-negative matrix factorization (NMF) is a group of algorithms in multivariate analysis and linear algebra where a matrix V can be factorized into two matrices W and H, with the property that all three matrices have no negative elements. This non-negativity can make the resulting matrices easier to inspect. In one aspect, the disclosed system automatically creates an optimal set of roles for a population of users given what access they currently have based on an NMF algorithm.

In some embodiments, a binary user-to-entitlement matrix X may be constructed, where X_ij is equal to one if user i has access to entitlement j. A binary user-to-job responsibility matrix D may also be constructed, where D_ij is equal to one if user j has job responsibility i. A “job responsibility” can be defined using any combination of attributes related to a user's role or responsibilities within the enterprise, such as job family, job level, department, reporting hierarchy, organization, etc. In addition, a “job responsibility” can be defined using one or more team attributes, such as supervisor name, team name, or team type. Orthogonal NMF can be used to compute an optimal factorization of the product of D and X. The result of the NMF may be a job responsibilities-to-roles matrix W and roles-to-entitlement matrix H.

In some embodiments, the factorization is constrained by the job responsibility matrix D. Conceptually, the constraint restricts how the system can group a population of users. For example, if the entitlement matrix X were factorized without being constrained by the job responsibility matrix D, then users could be grouped together arbitrarily. By constraining the factorization using matrix D, users will be grouped according to their job responsibilities. This constraint provides an improvement over conventional role engineering systems and methods as the applied constraint results in a mapping from roles to job responsibilities. In some embodiments, a new user (e.g., a new employee of the enterprise) can be automatically assigned entitlements within an enterprise computer system based on their job responsibilities. This might not be feasible without the user of the constraint.

In some embodiments, given the results from the NMF (the job to role matrix W and the role to entitlement matrix H), the algorithm may find optimal thresholds w, h by grid search with an objective function defined as a mixture of the ‘relevance’ and ‘coverage’ scores of a particular set of roles. These scores may be competing factors, and the algorithm allows for control of how these two metrics are used together. The ‘relevance’ score may be associated with a percentage of entitlements granted in a role set that users require. The ‘relevance’ score may be a measure of risk. For example, as ‘relevance’ is increased, over-provisioning of the entitlements may decrease. The ‘coverage’ score may be a percentage of entitlements that users want that are granted in a role set. The ‘coverage’ score may be a measure of benefit. For example, the larger the ‘coverage’ score, the fewer entitlements that must be requested individually. Ins some embodiments, the job to role matrix W and the role to entitlement matrix H may be approximated using the thresholds w, h (e.g., by rounding W and H using w and h).

As described herein, an ‘entitlement’ may refer to an act of gaining access rights to resources provided by an enterprise including, but not restricted to, access to compute resources, data source access, code repositories, etc. In one example, the resources provided by the enterprise may include internet, GITHUB, VPN, AWS, ENTRUST, or SUBVERSION.

As described herein, ‘binary role data’ or ‘role data’ may refer to a mapping of job responsibilities with one or more roles of a user within an enterprise. A ‘role’ may refer to a set of users entitled to perform particular tasks or actions on one or more resources of the enterprise computer system.

As described herein, ‘binary reduced entitlement data’ may refer to a mapping of roles to entitlements.

As described herein, a ‘preselected relevance-coverage parameter’ may refer to a parameter for generating the binary role data and the binary reduced entitlement data from the role data and the reduced entitlement data. For example, a relevance parameter (or score) may refer to what percentage of entitlements assigned to a particular user (or population of users) are needed by that user (or users). A coverage parameter (or score) may refer to what percentage of entitlements are actually provided by a given set of roles within a target population of users. In some configurations, the ‘preselected relevance-coverage parameter’ may be represented mathematically using an predetermined constant (λ) as shown below:

$${min}_{a , h} λ \cdot coverage + ( 1 - λ ) \cdot relevance$$

As described herein, an ‘approximation-orthogonality parameter’ may refer to a condition imposed on an objective function that penalizes against roles that share entitlements. For example, a penalty (with strength α) can be added to the objective function including a matrix D (mapping users to job responsibilities), a matrix A (mapping job responsibilities to roles) and a matrix H such that W=DA, where the matrix W is constrained by the matrix D such that the columns of the matrix W are in the span of the rows of the matrix D, as shown below:

$${min}_{A , H} {‖ DAH - X ‖}_{F}^{2} + α {‖ {HH}^{T} - I ‖}_{F}^{2} subj . to \text{:} A , H \geq 0$$

As described herein, an ‘approximation-orthogonality parameter’ may also refer to a condition imposed on an objective function that penalizes against solutions where roles share the same job responsibilities. This can be useful to avoid solutions with two or more roles designed, for example, just for software engineers. For example, a second penalty (with strength β) can be added to the objective function including the matrix D (mapping users to their job responsibilities), the matrix A (mapping job responsibilities and roles) and the matrix H such that W=DA, where the matrix W is constrained by the matrix D such that the columns of the matrix W are in the span of the rows of the matrix D, as shown below:

$${arg max}_{\overline{A} , \overline{H}} {‖ X - D \tilde{A} \tilde{H} ‖}_{F}^{2} + α {‖ \tilde{H} {\tilde{H}}^{T} - {I}_{R \times R} ‖}_{F}^{2} + β {‖ {\tilde{A}}^{T} \tilde{A} - {I}_{R \times R} ‖}_{F}^{2}$$

### Applications

In one aspect, the present disclosure can be used as a self-service tool with a dashboard that allows a user to query access requirements as well as automatically generate an optimal set of roles for a specified organization. In another aspect, the present disclosure simplifies access management within an enterprise by provisioning groups of related entitlements together. For example, the system described here can be used to design an optimal set of roles for a single department at a large company. The user can specify a subpopulation of current users in the department and can select the number of roles, the overlap penalties, and which entitlements to exclude from new roles. The user can specify, based on which job descriptors the roles should use, to assign entitlements. The system disclosed herein can use the current set of entitlements for the specified population to determine the optimal set of roles to create and can display the optimal set of roles in a user interface. The user can modify the optimal set of roles manually, download the optimal set of roles, and/or submit the optimal set of roles to be created in the system. This can be done for a small population (a single department) or for the entire company.

### System Architecture

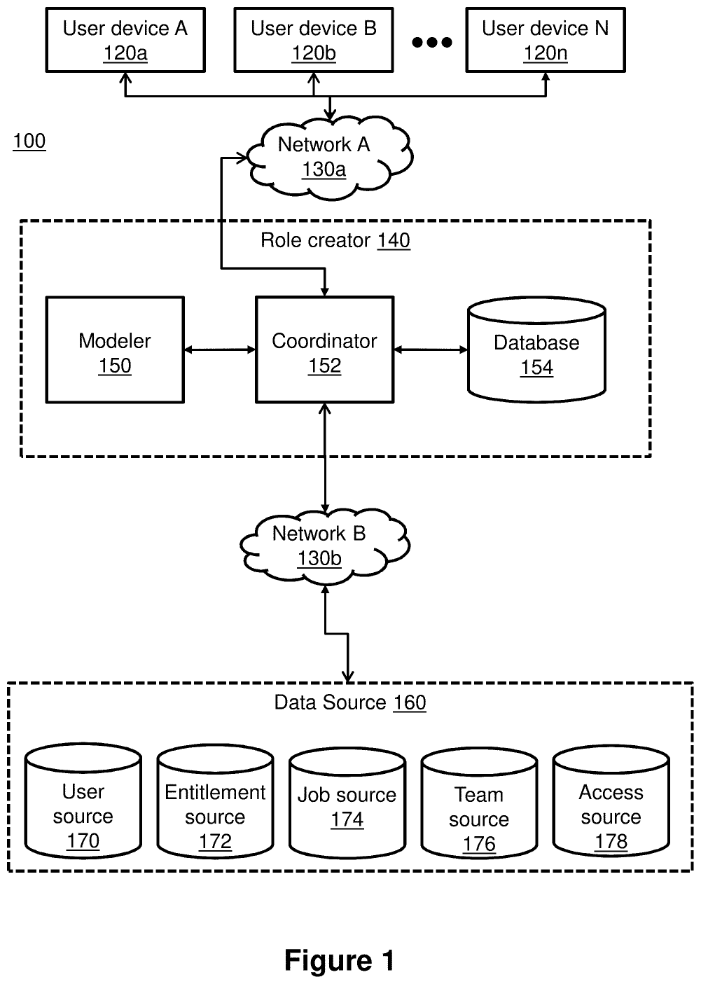

FIG. 1 is a block diagram of a system 100 for automated role engineering using non-negative matrix factorization, according to some embodiments of the present disclosure. The system 100 shown by FIG. 1 comprises one or more user devices 120, a network 130a, a network 130b, a role creator 140, and a data source 160. As shown in FIG. 1, the role creator 140 can include the modeler 150, the coordinator 152, and the database 154. The data source 160 can include a user source 170, an entitlement source 172, a job source 174, a team source 174, a team source 176, and an access source 178. In some configurations, the above components of the role creator 140 may be a publicly available cloud-computing component (e.g. Amazon Web Services). In alternative configurations, different and/or additional components may be included in the system 100.

The user devices 120 are one or more computing devices capable of receiving user input as well as transmitting and/or receiving data via the network 130a. In one embodiment, a user device 120 is a conventional computer system, such as a desktop or laptop computer. Alternatively, a user device 120 may be a device having computer functionality, such as a personal digital assistant (PDA), a mobile telephone, a smartphone or another suitable device. A user device 120 is configured to communicate via the network 130a. In one embodiment, a user device 120 executes an application which can communicate with role creator 140. For example, user device 120a may execute a browser application to enable communication of a user's job responsibility between the one or more user devices 120 and the role creator 140 via the network 130a. In another example, user device 120a may execute a browser application to enable communication of entitlements for assignment to a user between one or more user devices 120 and the role creator 140 via the network 130a. In another example, user device 120a may communicate a role number to the role creator 140.

User devices 120 may be configured to communicate via the network 130a, which may include any combination of local area and/or wide area networks, using both wired and/or wireless communication systems. In one embodiment, the network 130a uses standard communications technologies and/or protocols. For example, the network 130a includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130a include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130a may be represented using any suitable format, such as hypertext markup language (HTML) or extensible markup language (XML). In some embodiments, all or some of the communication links of the network 130a may be encrypted using any suitable technique or techniques. The network 130b may be the same as or similar to network 130a.

Network 130a or 130b may correspond to different types of networks, such as for example, the Internet, an intranet, a local area network (LAN), or a wide area network (WAN). It should be noted that the networks 130a, 130b may include any number of additional server devices, client devices, and other devices not shown. Program code located in the network 130 may be stored on a computer recordable storage medium and downloaded to a computer or other device for use. For example, program code may be stored on a computer recordable storage medium on a server (not shown here) and downloaded to the user device 120a over the network 130a for use on the user device 120a. FIG. 1 is intended as an example, and not as an architectural limitation for the different illustrative embodiments.

The role creator 140 is a system that creates roles within an enterprise computer system. A role within the enterprise may refer to a set of users entitled to perform particular tasks or actions on one or more secure resources (e.g., computer-based application and services). Alternatively, a role may be viewed as an intermediary between a set of users and a set of entitlements. A risk-averse role is a role that has a level of risk associated with it. An entitlement (sometimes referred to as an “access privilege” or “access right”) may grant, for example, a user assigned that particular entitlement the ability to read, write, delete, and/or modify a secure document. As another example, an entitlement may grant a user the ability to access and use a secure hardware device, software application, or network, such as a secure computer, financial application, or storage area network. A risk can be the expected negative impact of the calculated probability that a user will misuse or abuse an entitlement.

The role creator 140 may process access control data such as, previously implemented access control policies used by an enterprise. The previously implemented access control policies may be, for example, discretionary and/or mandatory access control policies. A discretionary access control policy allowed particular users to access secure resources according to their entitlements. A mandatory access control policy assigns security classifications to each of the secure resources and allows access only by users with distinct levels of security clearance. In addition, access control data may include user access logs or user access histories for each of the plurality of users. The user access logs may include information, such as which secure resources were accessed by a user, when the secure resources were accessed by the user, and what actions were performed on the secure resources by the user.

In some embodiments, the role creator 140 automatically performs mining of roles with constraints on the maximum risk levels that a resulting role-based access control policy can have. The problem is to mine access control policies that enable users to perform their assigned work while minimizing the aggregate risk to the enterprise due to potential misuse and/or attack from compromised accounts, malicious insiders, and incomplete coverage of access control policies.

In some embodiments, the role creator 140 may create role data and reduced entitlement data by constrained NMF through an iterative numerical method using an objective function that relies on one or more approximation-orthogonality parameters (e.g. which users, responsibilities, and entitlements are included in the analysis). In some configurations, the iterative numerical method may be used for fewer than 100 iterations. Role creator 140 may perform a matrix multiplication of a matrix representing the entitlement data (mapping of a plurality of users to a plurality of entitlements) and a matrix representing user job responsibilities (mapping of the plurality of users to a plurality of job responsibilities).

The modeler 150 can determine logical information associated with modeling the roles created by the role creator 140. In some embodiments, the modeler 150 may apply a role mining application to existing user-entitlement data to generate a set of candidate roles. These candidate roles may be considered as a set of entitlements. For example, the modeler 150 may apply a heuristic algorithm or a greedy algorithm to select an appropriate subset of candidate roles to include in the role-based access control policy, as well as to select which users to assign to which roles. The selection of these candidate roles to include in the role-based access control policy depends on a number of criteria, such as the weighted sum of the difference between the user-entitlement assignments in the input data and the resulting role-based access control policy, the complexity of the role-based access control policy, and the minimization of the aggregate risk of the role-based access control policy. When independent policy risk constraints are desired, any role assignment that causes the risk to exceed a predefined risk threshold level may be rejected.

In some embodiments, the modeler 150 may apply a greedy algorithm to the set of candidate roles such that the candidate roles minimize the cost function. For example, the modeler 150 may add candidate roles to the role-based access control policy in the order of the improvement (i.e., in a greedy manner) until adding additional candidate roles cannot decrease the cost function of the role-based access control policy. In another example, the modeler 150 may add candidate roles to the role-based access control policy until adding additional risk-averse roles increases the risk more than decreases the distance or complexity of the role-based access control policy or the total aggregate risk is greater than the predefined risk threshold, which is the total aggregate risk the role-based access control policy can withstand. This process of applying a greedy algorithm is useful in instances when the notion of a risk budget exists.

In some embodiments, the modeler 150 may include one or more web applications that apply a data mining and machine learning process to the existing access control policies, user access logs, user trust data, and permission sensitivity data to generate a role-based access control policy that satisfies multiple objectives, such as, for example, the ability of the newly generated role-based access control policy to express observed access control logs, while minimizing the operational risk of the newly generated role-based access control policy.

The coordinator 152 may coordinate the operation of one or more components of the role creator 140. The coordinator 152 may communicate with one or more components located within the role creator 140 during the creation of roles. As shown in FIG. 1, the coordinator 152 communicates with the modeler 150 and a database 154. The coordinator 152 is coupled to the user devices 120 through the network 130a. The coordinator 152 is also coupled to the user source 170, the entitlement source 172, the job source 174, the team source 176, and the access source 178 through the network 130b. In one example, the coordinator 152 retrieves a user's job responsibility from the user source 170 and stores the retrieved user's job responsibility in a database 154. In alternate embodiments, the coordinator 152 may communicate with the user devices 120 through the network 130b.

The database 154 can be a network storage device capable of storing data in a structured or unstructured format. The database 154 may store entitlement data that maps users to entitlements, and job responsibility data that maps users to job responsibilities. The database 154 may also store role data that maps job responsibilities to roles, and reduced entitlement data that maps roles to entitlements. In some configurations, database 154 may store binary role data that maps responsibilities to roles, binary reduced entitlement data that maps roles to entitlements, updated binary role data, and updated binary reduced entitlement data.

In some embodiments, database 154 may provide, for example, storage of: names and identification numbers of a plurality of users; user history data or access control logs for each of the plurality of users that may include listings of previously accessed secure resources, when the secure resources were accessed, and what actions were performed on the secure resources by the users; relationships between each of the plurality of users and their assigned entitlements to access secure resources; attributes that describe each of the plurality of users; and attributes that describe each of the assigned entitlements. Furthermore, database 154 may store other data, such as authentication data that may include user names, passwords, and/or biometric data associated with each of the plurality of users and system administrators of the access control policy service.

In the example of FIG. 1, user source 170 may store user job responsibilities, and a role number received from the client device 120. Entitlement source 172 may store information about entitlements that have been assigned or granted to users within the enterprise computer system. Job source 172 may store information about various jobs and job responsibilities, such as department, job family, job level, or organization, etc. Team source 176 may information about various teams, such as supervisor name, team name, or team type, etc. Access source 178 may store information indicating which users have access to which resources within the enterprise computer system.

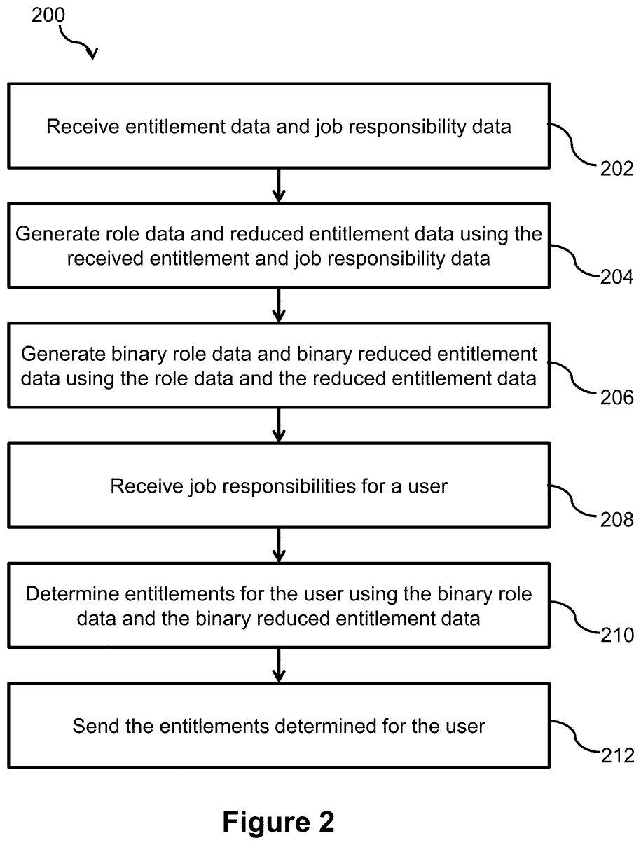

FIG. 2 is a flow diagram showing processing 200 that may occur within and be performed by system 100 of FIG. 1, according to some embodiments of the present disclosure. In some embodiments, other entities may perform some or all of the steps of the process 200. Likewise, embodiments may include different and/or additional steps, or perform the steps in different orders.

The system 100 may receive 202 (e.g., by role creator 140) entitlement data and job responsibility data. The entitlement data can map users to a plurality of entitlements (e.g. access right to compute resources, data source, code repositories, etc.), and the job responsibility data maps the users to job responsibilities.

The system 100 may generate 204 role data and reduced entitlement data from the received entitlement data. The generated role data can map job responsibilities to roles, and the generated reduced entitlement data can map roles to entitlements. In some configurations, the system 100 may generate role data and reduced entitlement data using a constraint defined by the job responsibility data. The system 100 may obtain role data and reduced entitlement data for a given number of roles.

The system 100 may generate 206 binary role data and binary reduced entitlement data from the role data and the reduced entitlement data. In some embodiments, the system 100 can generate binary role data and binary reduced entitlement data based on a preselected relevance-coverage parameter and stores them in the database 154.

The system 100 may receive 208, by the role creator 140, job responsibilities for a user. For example, the system 100 may receive information stored in job source 174 and/or team source 176.

The system 100 may determine 212 entitlements for the user using the binary role data and the binary reduced entitlement data. In some configurations, the system 100 allows the user to access one or more resources based on the determined entitlements.

The system 100 may send 214 to a user device 120a the entitlements for assignment to the user. For example, role creator 140 may communicate the entitlements for assignment to the user through network 130a.

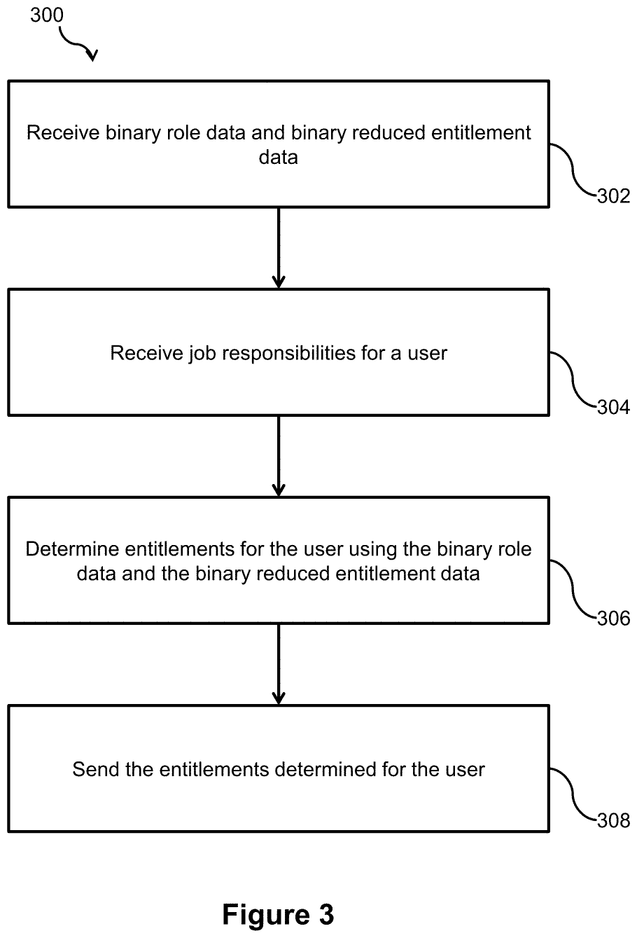

FIG. 3 is a flow diagram showing processing 300 that may occur within the system of FIG. 1, according to some embodiments of the present disclosure. The process 300 of FIG. 3 can be performed by system 100 of FIG. 1. In some embodiments, other entities may perform some or all of the steps of the process 300. Likewise, embodiments may include different and/or additional steps, or perform the steps in different orders.

The system 100 may receive 302 (e.g., from the database 154) binary role data and binary reduced entitlement data. As described above with reference to FIG. 1, the coordinator 152 coordinates with the database 154 to retrieve the binary role data and binary reduced entitlement data from the database 154 and communicates the retrieved binary role data and binary reduced entitlement data to the modeler 150.

The system 100 may receive 304 (e.g., from a user device 120a) job responsibilities for a user. In one example, the role creator 140 receives from the user device 120a a user's job responsibility.

The system 100 may determine 306 one or more entitlements for the user by using the binary role data and the binary reduced entitlement data. In one example, the system 100 may store the determined entitlements in the entitlement source 172.

The system 100 may send 308 (e.g., to user device 120a) the entitlements for assignment to the user. As described above with reference to FIG. 1, the role creator 140 may communicate the entitlements for assignment to the user through network 130a to user device 120a.

### Example for Automated Role Engineering Using Non-Negative Matrix Factorization

Disclosed below is an example of an algorithm for automated role engineering using NMF as performed by the system 100 of FIG. 1. In one aspect, the present disclosure relates to an example method that involves an entitlement matrix, X, for an arbitrary population of users and computes an optimal set of roles that provide as much access to those users as possible while also not over-provisioning and giving access to individuals who don't need access. To measure success, the method defines two metrics that can be computed for each individual person or aggregated-Coverage and Relevance.

Coverage relates to percentage of a user's access provided within a set of roles. For instance, if a user needs access to JIRA, AWS, and GITHUB, but the roles that apply to them only provide AWS and GitHub, then the method outputs that this user's coverage is ⅔ or 66%.

Relevance relates to percentage of access provided by a role that a user actually wants. For example, if a user needs access to JIRA, AWS, and GITHUB, but a set of roles provide access to AWS, GITHUB, TERADATA, and SAS, then this user's relevance would be 2/4 or 50% since they only actually need two of the four entitlements provided.

By defining two functions, c(A, H; X, D) and r(A, H; X, D), the system 100 computes the coverage and relevance for a set of roles specified by A and H, and then the system 100 solves the following:

$${arg max }_{A , H} λ \cdot c ( A , H ; X , D ) + ( 1 - λ ) \cdot r ( A , H ; X , D )$$

$$s . t . ∀ i , j {A}_{ij} ∈ \{ 0 , 1 \}$$

$$∀ i , j {H}_{ij} ∈ \{ 0 , 1 \}$$

Disclosed herein is a binary matrix factorization problem with a non-standard objective function. There are no closed-form solutions to this problem. Therefore, the system 100 takes an approximate approach to the problem, and does the following to arrive at A and H.

Let M be the number of users, N be the number of total entitlements, J be the total number of defined job responsibilities, R be the number of roles to create, α be the entitlement overlap penalty weight and β be the job overlap penalty weight. The method defines the following matrices:

$$1. {I}_{n \times n} \text{:} n \text{-} by \text{-} n indentity matrix$$

$$2. X ∈ {\{ 0 , 1 \}}^{M \times N} \text{:} entitlement matrix$$

$$3. {X}_{ij} = \{ \begin{matrix}1 & emp i has entitlement j \\ 0 & o . w .\end{matrix} \\ 4. D ∈ {\{ 0 , 1 \}}^{M \times J} \text{:} job responsibilities matrix \\ 5. {D}_{ij} = \{ \begin{matrix}1 & emp i has job responsibility j \\ 0 & o . w .\end{matrix} \\ 6. λ ∈ \{ 0 , 1 \} \text{:} coverage vs relevance tradeoff weight \\ 7. A ∈ {\{ 0 , 1 \}}^{J \times R} \text{:} job to role matrix \\ 8. {A}_{ij} = \{ \begin{matrix}1 & job i is assigned role j \\ 0 & o . w .\end{matrix} \\ 9. H ∈ {\{ 0 , 1 \}}^{R \times N} \text{:} job to role matrix \\ 10. {D}_{ij} = \{ \begin{matrix}1 & role i contains entitlement j \\ 0 & o . w .\end{matrix} \\ 11. Compute \tilde{A} ∈ {( {ℝ}_{\geq 0} )}^{J \times R} , \tilde{H} ∈ {( {ℝ}_{\geq 0} )}^{R \times N} from a \\ more standard NMF problem \text{:} {arg max}_{\overline{A} , \overline{H}} {‖ X - D \tilde{A} \tilde{H} ‖}_{F}^{2} + α {‖ \tilde{H} {\tilde{H}}^{T} - {I}_{R \times R} ‖}_{F}^{2} + β {‖ {\tilde{A}}^{T} \tilde{A} - {I}_{R \times R} ‖}_{F}^{2} \\ s . t . ∀ i , j {\tilde{A}}_{ij} \geq 0 \\ ∀ i , j {\tilde{H}}_{ij} \geq 0 \\ 12. Compute A and H by rounding \tilde{A} and \tilde{H} with two \\ real numbers , a and h \text{:} \\ {A}_{ij} = \{ \begin{matrix}1 & {\tilde{A}}_{ij} > a \\ 0 & o . w .\end{matrix} \\ {H}_{ij} = \{ \begin{matrix}1 & {\tilde{H}}_{ij} > h \\ 0 & o . w .\end{matrix} \\ 13. Given \tilde{A} and \tilde{H} , compute the optimal \\ a and h by solving \text{:} \\ {arg max (}_{a , h} λ \cdot c ( A , H ; X , D ) + ( 1 - λ ) \cdot r ( A , H ; X , D ) )$$

The method disclosed herein uses a brute force grid search for (13) since it is just a two-dimensional optimization. However, the method uses multiplicative update rules for (11):

$${\tilde{A}}_{n + 1} = {\tilde{A}}_{n} o \frac{{D}^{T} X {\tilde{H}}_{n}^{T} + 2 β {\tilde{A}}_{n}}{{D}^{T} D {\tilde{A}}_{n} {\tilde{H}}_{n} {\tilde{H}}_{n}^{T} + 2 β {\tilde{A}}_{n} {\tilde{A}}_{n}^{T} {\tilde{A}}_{m}}$$

$${\tilde{H}}_{n + 1} = {\tilde{H}}_{n} o \frac{{\tilde{A}}_{n}^{T} {D}^{T} X + 2 α {\tilde{H}}_{n}}{{\tilde{A}}_{n}^{T} {D}^{T} D {\tilde{A}}_{n} {\tilde{H}}_{n} + 2 α {\tilde{H}}_{n} {\tilde{H}}_{n}^{T} {\tilde{H}}_{n}}$$

where ⋅ is the Hadamard product, and division is done in a Hadamard-sense. In some embodiments, the system 100 does the following to arrive at A and H. For example,
Step 1: The system 100 starts the optimization by generating a random matrix A and H.
Step 2: In the first ten iterations, the system 100 can use the square root of the multiplicative update rules. After the first ten iterations, the system 100 can use the multiplicative update rules as described above.
Step 3: The system 100 can test for convergence in Frobenius norm of X-DAH and can call a solution converged if it is less than 0.1.
Step 4: The system 100 can proceed to step 1 if the solution has not converged.

### Examples of Improved User Interfaces for Automated Role Engineering

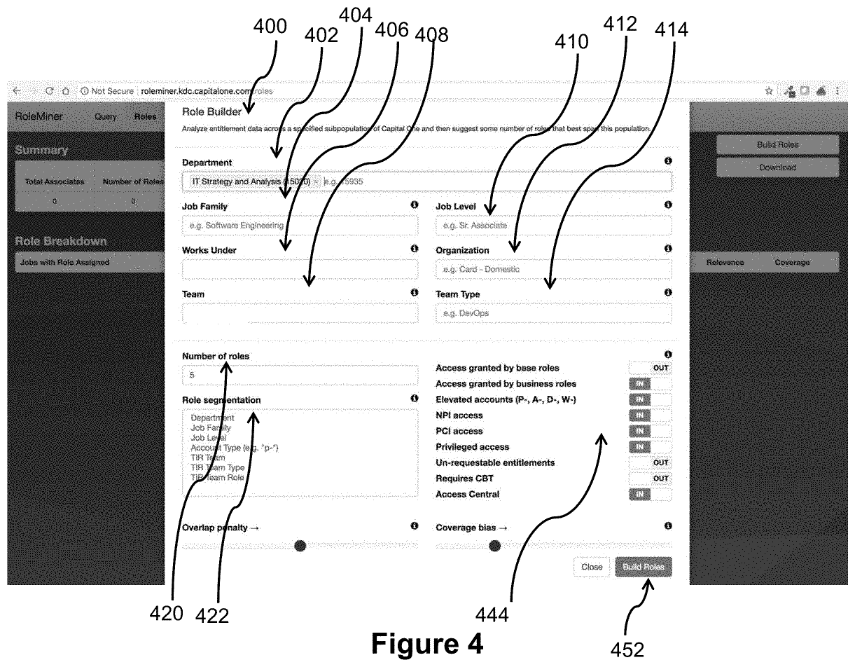

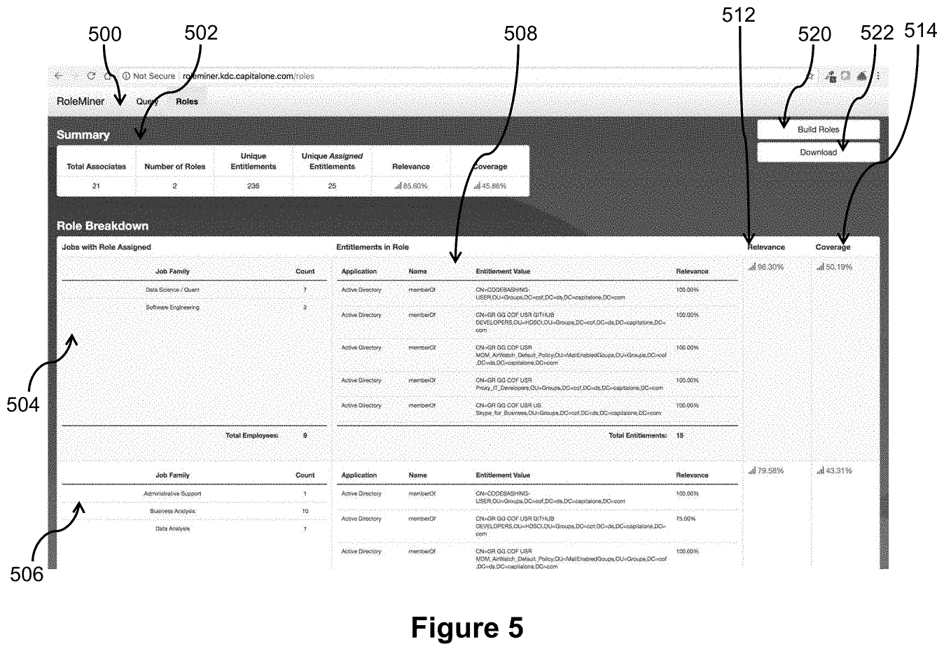

FIGS. 4 and 5 illustrate user interfaces that can be used for automated role engineering within the system 100 of FIG. 1, according to some embodiments of the present disclosure. Referring to FIG. 4, the user interface 400 illustrates a screenshot of a ‘Role Builder’ application implemented by the role creator 140. In one aspect, the user interface 400 is a website that analyzes entitlement data across a specified subpopulation of an enterprise. The user interface 400 may suggest some number of roles that best span the specified subpopulation. The user interface 400 displays a department field 402 with a user input (e.g. IT Strategy and Analysis) from the user device 120a. The job family field 404 may be populated with a user input, such as, Software Engineering. The works under field 406 may be populated with a user input, such as, “John Doe, CFO”. The team field 408 may be populated with a user input, such as “Team ABC”. The job level field 410 may be populated with a user input, such as Sr. Associate. The organization field 412 may be populated with a user input, such as Sr. Associate. The team type field 414 may be populated with a user input, such as DevOps.

In the example of FIG. 4, the user of the user device 120a may input the number of roles field 420 (e.g. five), and may also input a role segmentation (e.g. Job Family) by scrolling through the list 422. The user interface 400 includes a user input area 444 where the user of the user device 120a may determine settings such as access granted by base roles, access granted by business roles, elevated accounts, etc. The user interface 400 also includes a build roles button 452. For example, by clicking on the build roles button 452, the role creator 140 creates roles, as described above in conjunction with FIG. 1.

Referring to FIG. 5, the user interface 500 illustrates a screenshot of a ‘Role Miner.’ The user interface 500 includes a summary 502 that shows the results such as total associates (e.g. 21), number of roles (e.g. 2), unique entitlements (e.g. 236), unique assigned entitlements (e.g. 25), a relevance score (e.g. 85.60%), and a coverage score (e.g. 45.86%). The user interface 500 also includes a first breakdown information 504 that lists a first set of jobs with assigned roles and corresponding counts. The user interface 500 includes a second breakdown information 506 that lists a second set of jobs with assigned roles and corresponding counts. The user interface 500 includes an entitlements information 508 that lists a type of application, a name, an entitlement value, and a relevance information. In the example shown in FIG. 5, the entitlements information 508 includes a total of 15 entitlements. The user interface 500 also displays a relevance score 512 and a coverage score 514 calculated by the role creator 140. In addition, the user interface 500 includes a build roles 520 button and a download button 522. If the user of the user device 120a clicks the build roles 520 button, the role creator 140 determines entitlements for the user, such as described above in conjunction with FIG. 3. If the user of the user device 120a clicks the download button 522, the role creator 140 sends to the user device 120a the entitlements for assignment to the user as an output file (e.g. Excel Spreadsheet, text file, etc.)

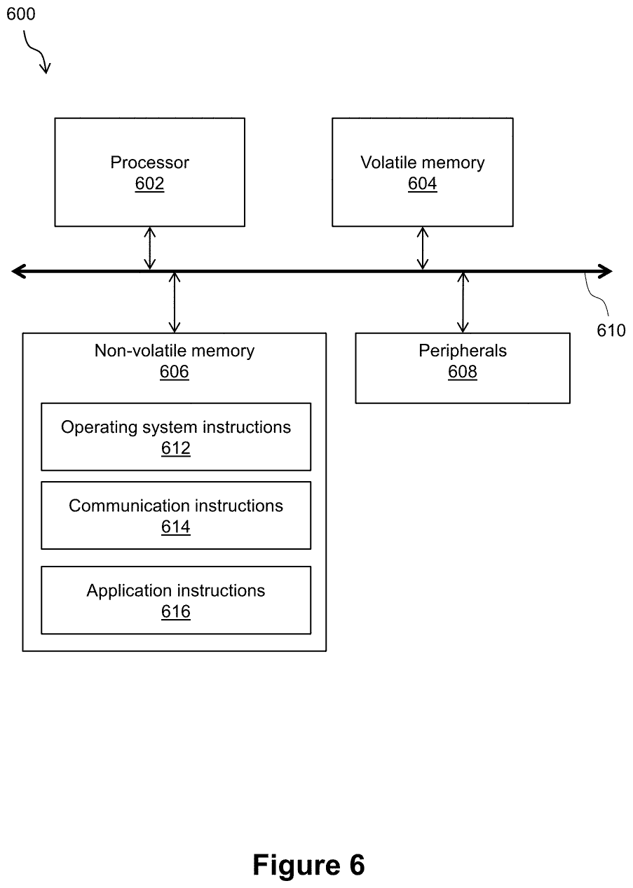

FIG. 6 is a block diagram of an example user device 600 that can perform at least part of the processing performed by the system 100 of FIG. 1, according to an embodiment of the present disclosure. User device 600 may include a processor 602, a volatile memory 604, a non-volatile memory 606 (e.g., hard disk), and peripherals 608, each of which is coupled together by a bus 610. Non-volatile memory 606 may be configured to store computer instructions 612, operating system 614, and data 616. In one example, computer instructions 612 are executed by the processor 602 out of the volatile memory 604. In some embodiments, the user device 600 corresponds to a virtual machine. In other embodiments, user device 600 corresponds to a physical computer.

Referring again to FIG. 6, processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Additionally, the software included as part of the concepts, structures, and techniques sought to be protected herein may be embodied in a computer program product that includes a computer-readable storage medium. For example, such a computer-readable storage medium can include a computer-readable memory device, such as a hard drive device, a CD-ROM, a DVD-ROM, or a computer diskette, having computer-readable program code segments stored thereon. In contrast, a computer-readable transmission medium can include a communications link, either optical, wired, or wireless, having program code segments carried thereon as digital or analog signals. A non-transitory machine-readable medium may include but is not limited to a hard drive, compact disc, flash memory, non-volatile memory, volatile memory, magnetic diskette, and so forth but does not include a transitory signal per se. In describing exemplary embodiments, specific terminology is used for the sake of clarity. For purposes of description, each specific term is intended to at least include all technical and functional equivalents that operate in a similar manner to accomplish a similar purpose.

Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A method for automatically assigning entitlements to users of an enterprise computer system, the method comprising:
receiving, by one or more processors, entitlement data that maps a plurality of users to a plurality of entitlements, wherein the entitlement data is represented by a matrix;
receiving, by the one or more processors, job responsibilities data that maps the plurality of users to a plurality of job responsibilities, wherein the job responsibilities data is represented by a matrix;
generating, by the one or more processors, a role data matrix and reduced entitlement data matrix by applying non-negative matrix factorization (NMF) to the entitlement data and the job responsibilities data, wherein the role data matrix maps the plurality of job responsibilities to a plurality of roles, wherein the reduced entitlement data matrix maps the plurality of roles to the plurality of entitlements;
applying, by the one or more processors, a mining algorithm to the role data matrix and the reduced entitlement data matrix to generate a role-based access control policy;
assigning, by the one or more processors, entitlements to the plurality of users based on at least a minimization of risk to the enterprise computer system, and a weighted sum of a difference between the entitlements in the entitlement data and the role-based access control policy.

2. The method of claim 1 comprising:
generating, from the role data matrix and the reduced entitlement data matrix, binary role data and binary reduced entitlement data using a predetermined relevance parameter and a predetermined coverage parameter,
wherein determining the one or more entitlements for the user comprises using the received job responsibility data, the binary role data, and binary reduced entitlement data.

3. The method of claim 1 comprising:
determining one or more roles for the user using the received job responsibility data and the role data matrix.

4. The method of claim 1 wherein applying non-negative matrix factorization (NMF) to the entitlement data and the job responsibilities data comprises using the job responsibilities data as a constraint.

5. The method of claim 1 wherein the entitlement data comprises a first binary matrix and the job responsibilities data comprises a second binary matrix.

6. The method of claim 1 comprising performing a matrix multiplication of a matrix representing the entitlement data and a matrix representing the job responsibilities data, wherein the non-negative matrix factorization (NMF) is applied to a result of the matrix multiplication.

7. The method of claim 1 wherein the plurality of job responsibilities comprises at least one of: a job family, a job level, a department, a reporting hierarchy, an organization, a supervisor name, a team name, or a team type.

8. The method of claim 1 wherein receiving job responsibility data for the user comprises receiving job responsibility data for a user having no prior entitlements within the enterprise computer system.

9. The method of claim 1 wherein the one or more entitlements comprise access rights to at least one of one: a compute resource, a data source, or a source code repository.

10. The method of claim 1 comprising:
receiving, from the user device, a request to update entitlements for the user;
receiving updated binary role data and updated binary reduced entitlement data; and
determining one or more updated entitlements for the user using the updated binary role data and the updated binary reduced entitlement data.

11. A method for automatically assigning entitlements to users of an enterprise computer system, the method comprising:
receiving, by one or more processors, a users-to-entitlements matrix and users-to-job responsibilities matrix;
generating, by the one or more processors, a job responsibilities-to-role matrix and a role-to-entitlements matrix by applying non-negative matrix factorization (NMF) to a product of the users-to-entitlements matrix and the users-to-job responsibilities matrix;
applying, by the one or more processors, a mining algorithm to the job responsibilities-to-role matrix and a role-to-entitlements matrix to generate a role-based access control policy;
assigning, by the one or more processors, entitlements to the plurality of users based on at least a minimization of risk to the enterprise computer system, and a weighted sum of a difference between the entitlements in the users-to-entitlements matrix and the role-based access control policy.

12. The method of claim 11 comprising:
generating, from the responsibilities-to-role matrix, a binary responsibilities-to-role matrix using at least one of a predetermined relevance parameter or a predetermined coverage parameter,
wherein determining the role for the user comprises using the job responsibility data for the user and the binary job responsibilities-to-role matrix.

13. The method of claim 11 comprising:
generating, from the role-to-entitlements matrix, a binary role-to-entitlements matrix using at least one of a predetermined relevance parameter and a predetermined coverage parameter,
wherein determining the one or more entitlements for the user comprises using the role determined for the user and the binary role-to-entitlements matrix.

14. The method of claim 11 wherein applying non-negative matrix factorization (NMF) to the product of the users-to-entitlements matrix and the users-to-job responsibilities matrix comprises using the users-to-job responsibilities matrix as a constraint.

15. The method of claim 11 wherein the users-to-entitlements matrix comprises a binary matrix that maps the plurality of users to a plurality of entitlements, wherein the users-to-job responsibilities matrix comprises a binary matrix that maps the plurality of users to a plurality of job responsibilities.

16. The method of claim 11 wherein receiving job responsibility data for the user comprises receiving job responsibility data for a user having no prior entitlements within the enterprise computer system.

17. The method of claim 11 wherein the one or more entitlements comprise access rights to at least one of one or more compute resources, one or more data source, one or more code repositories associated with the enterprise computer system.

18. The method of claim 11 comprising performing a matrix multiplication of the users-to-entitlements matrix and the users-to-job responsibilities matrix.

19. The method of claim 11 wherein applying non-negative matrix factorization (NMF) comprises performing an iterative numerical method using an objective function that relies on one or more approximation-orthogonality parameters.

20. A system comprising:
a database;
one or more processors; and
memory storing instructions executable by the one or more processors to:
receive, from the database, entitlement data that maps a plurality of users to a plurality of entitlements, wherein the entitlement data is represented by a matrix;
receive, from the database, job responsibilities data that maps the plurality of users to a plurality of job responsibilities, wherein the job responsibilities data is represented by a matrix;
generate a role data matrix and reduced entitlement data matrix by applying non-negative matrix factorization (NMF) to a product of the entitlement data and the job responsibilities data, wherein the role data matrix maps the plurality of job responsibilities to a plurality of roles, wherein the reduced entitlement data maps the plurality of roles to the plurality of entitlements;
apply a mining algorithm to the role data matrix and reduced entitlement data matrix to generate a role-based access control policy;
assigning, by the one or more processors, entitlements to the plurality of users based on at least a minimization of risk to the enterprise computer system, and a weighted sum of a difference between the entitlements in the entitlement data and the role-based access control policy.
